(19) United States
(12) Patent Application Publication
(10) Pub. No.: US 2012/0165597 A1
(43) Pub. Date: Jun. 28, 2012

(54) IMPLANTABLE PIEZOELECTRIC POLYMER FILM MICROPHONE

(75) Inventors: Timothy L. PROULX, Santa Cruz, CA (US); Reza KASSAYAN, Atherton, CA (US)

(73) Assignee: Sonitus Medical, Inc., San Mateo, CA (US)

(21) Appl. No.: 13/197,769

(22) Filed: Aug. 3, 2011

Related U.S. Application Data
(60) Provisional application No. 61/370,411, filed on Aug. 3, 2010.

(51) Int. Cl. H04R 25/00

(52) U.S. Cl. 600/25

(57) ABSTRACT

Implantable piezoelectric polymer film microphone apparatus and methods are described for use as an integral component of a hearing augmentation device system. The piezoelectric polymer film can be polyvinylidene fluoride (“PVDF”). Generally, a piezoelectric polymer film serves as the sensor that is well matched to tissue and which directly converts to an electrical signal by the piezoelectric effect vibration signals which are received through the tissue in which the piezoelectric polymer film microphone is implanted.

### CROSS-REFERENCE TO RELATED APPLICATIONS

This application claims the benefit of priority to U.S. Prov. App. 61/370,411 filed Aug. 3, 2010, which is incorporated herein by reference in its entirety.

### FIELD OF THE INVENTION

The present invention relates to methods and apparatuses for implantable microphones in particular microphones using piezoelectric polymer film technology, which may be used as part of hearing aid systems.

### BACKGROUND OF THE INVENTION

In many implantable hearing aid systems, much of, if not all of, the components of the system are positioned subcutaneously on, within or adjacent to a patient's skull, such as proximate to the mastoid process. Depending on whether some or all of the components are implanted, implantable hearing augmentation systems may be classified as either semi-implantable or fully implantable. In a semi-implantable hearing augmentation device system, one or more components of the system such as a microphone, signal processor, and transmitter may be externally located to receive, process, and inductively transmit an audio signal to implanted components such as a transducer. In a fully-implantable hearing aid system, typically all of the components, e.g., the microphone, signal processor, and transducer, are located subcutaneously. In either arrangement, an implantable transducer is utilized to stimulate a component of the patient's auditory system (e.g., tympanic membrane, ossicles and/or cochlea).

A fully implantable hearing aid system, such as those used to stimulate the tympanic membrane, the ossicles or the cochlea have inherent advantages over traditional hearing aid systems and semi-implantable hearing aid systems because a fully implantable system is completely unobservable, eliminating the appearance of a handicap; it does not occlude the ear canal, eliminating comfort/incompatibility issues and improving low frequency sound perception for those with partial hearing loss; and it allows use in environments or activities incompatible with traditional hearing aids. Enablement of a fully implantable hearing aid system requires an implantable microphone with suitable performance.

Implantable microphones described in the art for use with implantable hearing aid systems generally employ an air-conduction type electret microphone encapsulated in a biocompatible housing with a membrane that defines an air chamber. These microphones are installed subcutaneously just above and behind the ear (U.S. Pat. No. 6,626,822), within the bony wall of the auditory canal (U.S. Pat. No. 6,516,228) or at other locations in the soft tissue separated from skull-borne vibrations (U.S. Pat. No. 7,354,394). A thin layer of tissue covering the microphone acts as an extension of the microphone diaphragm and couples vibrations induced by external air pressure disturbances to the embedded microphone sensor. Signals detected by the microphone may be processed, amplified and sent to an implanted transducer for stimulation of the middle ear, tympanic membrane or to electrodes for stimulation of the auditory nerve.

implantable microphones that rely on conversion of air-pressure changes within a sealed cavity to stimulate an encapsulated electret-type microphone are concerned with cavity dimensions, enclosed air pressure and membrane stiffness to provide an acceptable tradeoff between resonance frequency and sensitivity of the device. Since an implantable microphone must necessarily be hermetically sealed, with an implantable electret-type microphone, internal pressure cannot be equalized to atmosphere, so the size of the cavity affects the restoring force on the diaphragm and therefore the microphone sensitivity. Similarly, a stiff diaphragm causes a higher resonance frequency, but lower sensitivity due to the forces needed to move the membrane.

An implantable microphone using piezoelectric polymer film such as polyvinylidene fluoride (“PVDF”) may overcome the limitations of electret-type implantable microphones because it is well suited for detecting sound-induced vibration in tissue (whether vibration of a thin diaphragm or vibrational waves propagating through tissue) due to its high piezoelectric voltage constant, g, which relates voltage to induced strain, its low mechanical impedance, which is well matched to tissue and its general robustness and mechanical stability. Additionally, with piezoelectric polymer film, vibration is directly converted to an electrical signal by the piezoelectric effect, in contrast to existing electret-type implantable microphones that rely on conversion of mechanical vibration to pressure changes in an enclosed air cavity for subsequent detection by an air-conduction microphone.

The present invention seeks to address the limitations of electret-type (air-conducting) microphones for use in implantable hearing aids systems by providing a piezoelectric polymer film microphone that serves as an integral part of a fully implantable hearing aid system, such as a middle ear implant or cochlear implant. The piezoelectric polymer film design allows for a small package size, relative ease of construction, high durability and improved signal to noise ratio compared to implantable electret-based microphones.

### SUMMARY OF THE INVENTION

The present invention comprises an implantable piezoelectric polymer film tissue conduction microphone for use with an implantable hearing aid system further comprising, a biocompatible housing, a piezoelectric polymer film mechanically coupled to tissue, signal conditioning electronics contained within the housing, and multiple electrically insulated leads disposed through the housing for connection to a separate implanted battery and control unit for the hearing device. In one embodiment, the piezoelectric polymer film may comprise polyvinylidene fluoride (“PVDF”). In another embodiment, the piezoelectric polymer film may comprise co-polymers of PVDF such as PVDF-TrFE; PVDF-TrFE-PZT; ferroelectric polymers; piezoelectric ceramic precursors; terpolymers of vinylidene fluoride; trifluoroethylene; ch lorofluoroethylene; silicon carbide (SiC)/PVDF composites. In yet another embodiment, the housing is cylindrical in shape to facilitate the anchoring of the microphone into the bone of the patient. In yet another embodiment, the piezoelectric polymer film is attached to a curved open frame structure such that the film serves as a diaphragm and seals one end of the housing. A thin biocompatible protective layer is disposed on the surface of the film and is in contact with the tissue.

In another embodiment, a piezoelectric polymer film microphone uses a non-curved (i.e., flat) open frame structure. In this case, the spherically pre-formed piezoelectric polymer film is self supported and is attached around its perimeter to the frame. The curvature may be directed toward the tissue to present a convex surface, or preferably (due to mechanical stability when loaded with tissue) a concave surface. In the case of a concave surface, the depression is filled with a cast silicone rubber contact layer to provide a flat or slightly convex tissue-contact surface. A self supported cylindrical sensor may alternatively be created by clamping/bonding the edges of the film (in the I-direction) but leaving the sides free. Curvature in the edge-supported cylindrical film may be induced by pre-forming the film or by casting/bonding a cylindrically-curved silicone rubber layer onto its surface to present a flat or slightly convex tissue-contact surface.

In yet another embodiment, a piezoelectric polymer film microphone incorporates a film wrapped around a silicone rubber contact pad in which a normal force on the pad generates a tension in the film axis due to the radial expansion of the rubber pad. The rubber contact pad incorporates a cylindrical section that is clamped against a stiff platform incorporated into the housing. The piezoelectric polymer film is wrapped around the cylinder and bonded to itself with an epoxy or cyanoacrylate or other adhesive.

In yet another embodiment, a curved piezoelectric polymer film surface is created using a solid curved frame with ridges that support the film and create thin air gaps between the film and frame. Small holes in the frame couple the air gaps with the air cavity behind the plate to reduce stiffness of the system. This arrangement may provide improved mechanical stability and reduce the effect of low frequency vibrations traveling within the tissue, such as those caused by user movements or breathing. It also provides additional microphone design flexibility, in that hole sizes and spacing and size of supporting ridges can be adjusted to fine tune the response.

The implantable piezoelectric polymer film microphone of the present invention (including, but not limited to, the PVDF microphone) may be subcutaneously implanted in the bony or cartilaginous wall of the ear canal, disposed on the surface or implanted in the temporal bone on the posterior or anterior side of the ear (mastoid region), or in any soft tissue in a region that facilitates the reception of acoustic signals. The implantable piezoelectric polymer film microphone of the present invention may be anchored into the posterior bony wall of the ear canal. This allows the microphone to take advantage of the natural sound amplification provided by the ear geometry, and makes implantation easier because of the thin dermis layer in this anatomical region. Additionally, this mounting may protect the piezoelectric polymer film microphone from mechanical damage. If mounted to the bone of the skull, the implantable piezoelectric polymer film microphone of the present invention may incorporate a rubber spacer to reduce the effect of bone-conducted vibrations caused by the user's speech.

### BRIEF DESCRIPTION OF THE DRAWINGS

FIG. 1 shows an example of how a curvature translates normally directed pressure into tensile stresses along the film axis that can be much larger than the applied stress.

FIG. 2 shows a piezoelectric film microphone incorporating a film wrapped around a deformable pad, such as a silicone or other rubber contact pad in which a normal force on the pad generates a tension in the film axis due to the radial expansion of the rubber pad.

FIG. 3 shows a piezoelectric film with the stretch direction (1-direction) indicated, where the edges of the film (in the 1-direction) are clamped but the sides are not.

FIG. 4 shows the implantable piezoelectric polymer film microphone of the present invention implanted in the temporal bone on the posterior or anterior side of the ear (mastoid region).

FIGS. 5A and 5B show cross-sectional side and top views, respectively, of one embodiment of a microphone comprising a curved frame defining a circular opening which supports a piezoelectric polymer film.

FIGS. 6A and 6B show cross-sectional side and top views, respectively, of another embodiment of a microphone comprising a curved frame defining a rectangular opening which supports a piezoelectric polymer film.

FIGS. 7A and 7B show cross-sectional side and top views, respectively, of another embodiment of a microphone comprising a non-curved frame with a pre-formed piezoelectric polymer film that is self supported and incorporates a silicone rubber tissue contact lens. The silicone rubber lens induces a curvature in the piezoelectric polymer film.

FIGS. 8A and 8B show cross-sectional side and top views, respectively, of another embodiment of a microphone comprising a non-curved frame defining a rectangular opening with a silicone rubber lens which defines a curvature for the piezoelectric polymer film.

FIGS. 9A and 9B show cross-sectional side and top views, respectively, of another embodiment of a microphone having a curved frame with ridges that support a piezoelectric polymer film and create thin air gaps between the film and frame. The air gaps couple to an air cavity behind the frame via small holes in the frame.

FIGS. 10A and 10B show anterior and side views, respectively, of an example of the microphone implanted in subcutaneous tissue within, e.g., the neck, torso, etc. beneath the skin.

FIG. 11 shows a cross-sectional side view of the microphone of FIG. 8 implanted subcutaneously in the bony wall of the ear canal.

FIG. 12 shows a cross-sectional side view of the microphone assembly of FIG. 2 implanted subcutaneously in the bony wall of the ear canal.

FIGS. 13A and 13B show cross-sectional anterior and side views, respectively, of another example of the microphone of FIGS. 5 and 6 implanted in the bony wall of the ear canal.

FIGS. 14A and 14B show cross-sectional view of microphone having a housing that enables the implantation of the microphone within or along the skull in proximity to the patient's outer ear, e.g., posterior or anteriorly of the outer ear.

### DETAILED DESCRIPTION OF THE INVENTION

All patents and patent applications cited herein are incorporated by reference in their entirety.

The piezoelectric polymer film microphone of the present invention is implanted in suitable sites of the body by surgical techniques that are used for the implantation of electret-type microphones, which are well known to those of skill in the art. The piezoelectric polymer microphone of the present invention may be subcutaneously implanted in the bony or cartilaginous wall of the ear canal (i.e., the bony wall of the ear canal), disposed on the surface or mounted to the temporal bone on the posterior or anterior side of the ear (mastoid region), or in any soft tissue in a region that facilitates the reception of acoustic signals such as in the soft tissue of the neck, or in other locations as described in U.S. Pat. Nos. 6,626,822, 6,516,228 and 7,354,394. The microphone may be anchored into the posterior bony wall of the ear canal to take advantage of the natural sound amplification provided by the ear geometry, and because of the thin dermis layer in this area making implantation easier. Additionally, this mounting may protect the microphone from mechanical damage. If mounted to the bone of the skull (i.e., the mastoid bone) the piezoelectric polymer film microphone of the present invention may incorporate a rubber spacer to reduce the effect of bone-conducted vibrations caused by user speech.

To reduce size and enable a secure attachment to the bony wall of the ear canal or to the mastoid by osteointegration, a housing (such as a cylindrical housing) having screw-type threads or groove features for engagement with the bone and to facilitate insertion therein may be employed. The threads may extend over the majority of the housing length (such as for full insertion into the bony wall), or on a distal portion of the housing (such as for partial insertion into the bone of the skull). The housing may be machined or manufactured from titanium or other biocompatible metals known in the art, such as stainless steel or gold, or from any type of implant-grade plastic known in the art such as PEEK. A plastic housing incorporating a conductive paint or metal plating on its interior may be used to reduce susceptibility of the microphone to electromagnetic interference. The housing may incorporate a distal flange that improves mechanical positioning and anchoring in place, especially in those areas of the skull in which the housing is positioned adjacent to an air void or cavity, such as that shown in FIG. 11. The housing may be other shapes than cylindrical, such as oval or rectangular, depending on the implant location or method of attachment, as one skilled in the art may readily discern.

In one embodiment, the piezoelectric polymer film microphone sensor of the present invention is constructed by bonding (e.g., with cyanoacrylate, epoxy or double-sided adhesive) or, in the case of PVDF film, by mechanically clamping a pre-formed spherically shaped PVDF film (e.g., 5 mm diameter) to a spherically curved and open titanium frame. In the case in which the piezoelectric polymer film microphone of the present invention is comprised of PVDF film, the PVDF film is pre-formed by stretching it over a steel sphere at elevated temperature (e.g., 80° C.), under a poling field of 40V/micron (R. Lerch, “Electroacoustic transducers using piezoelectric polyvinylidene fluoride films”, J. Acoust. Soc. Amer., vol. 66, no. 4, pp. 952-954, 1979. Alternatively, pre-forming can be avoided by attaching a rectangular layer of PVDF film (e.g., 5×5 mm, 100 micron thick) to a curved and open frame such that the stretch direction (known as the “1” direction) of the film is along the radius of curvature of the frame (U.S. Pat. No. 6,937,736). Other piezoelectric polymer films such as copolymers of PVDF (e.g., PVDF-TrFE; PVDF-TrFE-PZT; ferroelectric polymers; piezoelectric ceramic precursors; terpolymers of vinylidene fluoride; trifluoroethylene; chlorofluoroethylene; silicon carbide (SiC)/PVDF composites; etc.) also may be used and are contemplated as part of the present invention.

In one embodiment, the frame is machined from a biocompatible metal, such as 304 or 316 stainless steel or titanium. To minimize the amount of inactive film material (which adds to parasitic capacitance), the width of the frame edge is maintained at a practical minimum to effectively clamp the film and resist deflection. A width of about 1 mm may be used. Radius of curvature directly impacts microphone sensitivity and resonance frequency (due to the effect on film compliance). A frame radius of, e.g., 10 mm-25 mm, may be used to provide a resonance frequency above the primary speech frequency band (e.g., 300-4 kHz) while maintaining sufficient device sensitivity.

In one embodiment, signal conditioning circuitry is positioned as close as possible to the sensor to drive further electrical stages or electrical leads. The pre-amplifier incorporates a high input impedance (e.g., >10M Ohm) JFET transistor for impedance conversion and signal gain and is packaged with the sensor in the microphone housing. The JFET amplifier has lower electronic noise than typical MOSFET amplifiers used for electret-based microphones. High pass filtering may be employed after signal amplification to reduce electronic noise below, e.g., 100 Hz. Depending on the distance between the microphone sensor and the hearing device control unit, and at the expense of sensitivity, the pre-amplifier may alternatively be located in the control unit, further simplifying the microphone design and reducing overall size.

In one embodiment, the PVDF film sensor includes a termination board or termination pads that allow attachment to the enclosed pre-amplifier by mechanical means or by conductive epoxy (e.g. E-Solder®, Von Roll Isola). The conditioned output signals are connected to the exterior of the housing by means of small lead through connector hermetically sealed into the housing. A thin, flexible shielded cable or individual (twisted) insulated wires connect the microphone to the battery/control unit. The electrical termination scheme may alternately utilize lithographically formed wires in a thin laminate for connection to hermetically sealed lead-throughs as described in U.S. Pat. No. 6,516,228 incorporated herein by reference.

In another embodiment, the frame with attached PVDF diaphragm is integrated into the microphone housing by mechanical fasteners or adhesives creating a hermetic seal. To protect the exposed PVDF electrode surface, a conformal layer of biocompatible polymer (e.g., 50 microns of parylene C) is vapor deposited onto the sensor to create a contact layer. The polymer provides a good match between the PVDF and the tissue. Alternate contact layer materials include polyimide or polyester laminates that may be incorporated into the film during its fabrication or applied by adhesives during microphone construction, or a thin layer of implant grade silicone rubber (e.g., Applied Silicone LSR30) cast onto the microphone diaphragm surface. To minimize mechanical loading effects and to reduce the microphone profile, the contact layer may be limited to 0.5 mm thickness.

In an alternate embodiment, a piezoelectric polymer film sensor uses a non-curved (i.e., flat) frame structure, e.g., an open frame structure. In this particular embodiment, the spherically pre-formed PVDF film is self supported and is attached around its perimeter to the frame. The curvature may be directed toward the tissue to present a convex surface, or preferably (due to mechanical stability when loaded with tissue) a concave surface. In the case of a concave surface, the depression is filled with a cast silicone rubber contact layer to provide a flat or slightly convex tissue-contact surface. In an alternate embodiment, a self supported cylindrical sensor may be created by clamping/bonding the edges of the film (in the 1-direction) but leaving the sides free. Curvature in the edge-supported cylindrical film may be induced by pre-forming the film or by casting/bonding a cylindrically-curved silicone rubber layer onto its surface to present a flat or slightly convex tissue-contact surface.

In yet a further embodiment, a curved piezoelectric polymer film surface is created using a solid curved frame with ridges that support the film and create thin air gaps between the film and frame. Small holes in the frame couple the air gaps with the air cavity behind the plate (R. Lerch, G. M. Sessler, “Microphones with rigidly supported piezopolymer membranes”, J. Acoust. Soc. Amer., vol. 67, no. 4, pp. 1379-1381, 1980) to reduce stiffness of the system. This embodiment is designed to provide improved mechanical stability and reduce the effect of low frequency vibrations traveling within the tissue, such as those caused by user movements or breathing. It also provides additional microphone design flexibility, in that hole sizes and spacing and size of supporting ridges can be adjusted to fine tune the response.

In an alternate embodiment, a piezoelectric polymer film tissue contact microphone incorporates a film wrapped around a silicone rubber contact pad in which a normal force on the pad generates a tension in the film axis due to the radial expansion of the rubber pad. The rubber contact pad incorporates a cylindrical section that is clamped against a stiff platform incorporated into the housing. The piezoelectric polymer film is wrapped around the cylinder and bonded to itself with an epoxy or cyanoacrylate or other adhesive. A small exposed tab allows access to the bottom electrode. Electrical leads are attached to both top and bottom electrodes and routed through holes in the platform to the microphone enclosure for signal conditioning and amplification.

Piezoelectric film such as PVDF is well suited for use as an implantable tissue contact sensor due to its high piezoelectric voltage constant, g, which relates voltage to induced strain, its low mechanical impedance, which is well matched to tissue and its general robustness and mechanical stability. Additionally, with piezoelectric film, tissue vibration is directly converted to an electrical signal by the piezoelectric effect, in contrast to contact sensors that rely on conversion of mechanical vibration to pressure changes in an enclosed air cavity for subsequent detection by an air-conduction microphone (such as those described in U.S. Pat. Nos. 6,516,228 and 7,433,484).

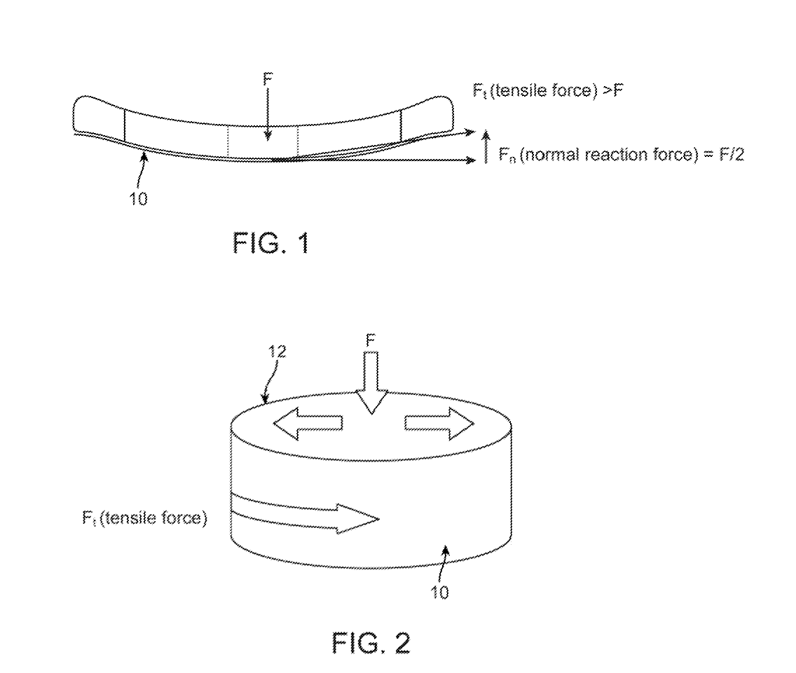

When clamped to a curved open frame structure, a piezoelectric polymer film 10, such as a PVDF film, provides very high sensitivity to normally directed mechanical displacement and its frequency response is flat when operated below resonance. The curvature translates a normally directed pressure or force F into tensile stresses along the film axis that can be much larger than the applied stress (FIG. 1). The induced film strain generates charge on the film electrodes in proportion to the applied pressure. Film thickness; radius of curvature (ROC) and electrode area may be adjusted to affect electrical impedance, sensitivity, resonance frequency and mechanical impedance, thus allowing fine tuning to the application. FIG. 2 illustrates an example where a normally directed force F may be applied to a curved structure 12, which induces radial expansion over the curved structure and generates a tensile force in the circumferentially bonded film.

The microphone sensor can be constructed by bonding (e.g., with cyanoacrylate, epoxy or double-sided adhesive) or mechanically clamping a layer of piezoelectric polymer film such as PVDF film (e.g. 10 mm×20 mm, 52 micron thick) to a curved and open metal frame such that the stretch direction (known as the “1” direction) of the film is along the radius of curvature of the frame (U.S. Pat. No. 6,937,736 incorporated herein by reference). Other piezoelectric films such as copolymers of PVDF (e.g., PVDF-TrFE) may also be used.

The frame may be constructed of a biocompatible metal, such as 304 or 316 stainless steel or titanium. To minimize the amount of inactive film material (which adds to parasitic capacitance), the width of the frame edge is maintained at a practical minimum to effectively clamp the film and resist deflection. A width of, e.g., 1-2 mm, may be used in one example. Radius of curvature directly impacts microphone sensitivity and resonance frequency (due to the effect on film compliance). A frame radius of, e.g., 5 mm-20 mm, may be used to provide a resonance frequency above the primary speech frequency band (e.g., 300-4 kHz) while maintaining sufficient device sensitivity. The frame is integrated into the microphone housing, e.g., by mechanical fasteners or adhesives. Moreover, the frame may be configured in a number of different shapes, elliptical, circular, etc. depending upon the desired characteristics. Additionally, in alternative variations, the frame may be omitted from the enclosure and/or the piezoelectric polymer film may be secured directly to the housing and unsupported by the frame while the piezoelectric polymer film remains adhered to and in vibrational contact with the contact surface of the enclosure.

A contact layer (lens) of silicone RTV or polyurethane rubber (e.g., NuSil Med-6015 or Dow Corning X3-6121) is cast in place on the piezoelectric polymer film 10. The lens casting process ensures intimate mechanical contact between the lens and piezoelectric polymer film (such as PVDF film) over the entire surface and acts to seal the front surface of the microphone assembly from liquid intrusion. An alternate approach is to attach a piezoelectric polymer film to a pre-molded rubber contact layer using a flexible adhesive. This requires care to ensure intimate contact over the active film surface and a water-tight seal at the lens/housing interface. To minimize mechanical loading effects and to reduce the microphone profile, the contact lens may be limited, e.g., to 1-2 mm in thickness.

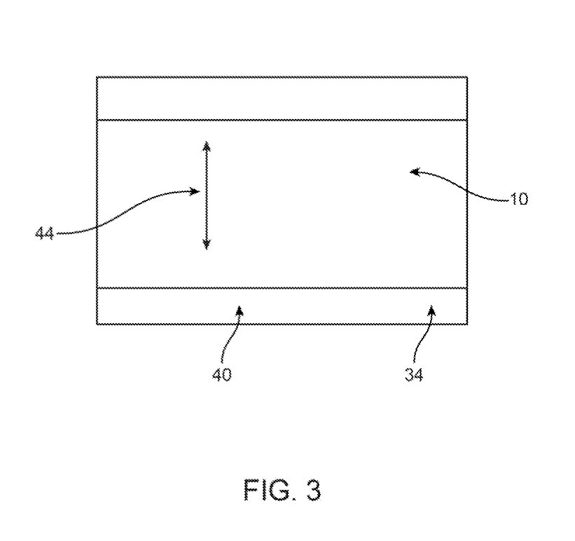

FIG. 3 shows an alternate arrangement for a piezoelectric film 10 uses a flat open frame 34 where the first set of edges of the film opposite to one another (in the 1-direction 44) are clamped 40 but the opposing second set of sides are not. Static (i.e., “DC”) pressure on the contact lens 40 (such as when installed against the tissue) causes the film to deflect from a straightened or flattened neutral position, resulting in the curved configuration described above. Here, the amount of induced curvature is defined by the DC force applied, thus sensitivity and frequency response of the sensor will vary during use. However, this arrangement may result in a light/smaller device and simplified construction.

With this architecture, the amount of film curvature may be alternatively adjusted/controlled electronically by applying a DC electric field by means of a DC boost converter circuit connected via leads to first and second electrodes.

Alternately, the desired piezoelectric film curvature may be achieved by adhering the film to a rubber contact layer having a pre-defined curvature using a flexible adhesive and clamping the edges (in the 1-direction) between the frame and housing.

As with the curved/clamped film arrangement described earlier, the tensile force acts on the edge of the film; the small effective area of the film edge causes a much higher stress than that measured at the surface of the film, resulting in higher voltage for the same incoming pressure.

The high capacitance of the piezoelectric polymer film (such as the PVDF film) or electret microphone sensor calls for signal conditioning circuitry positioned as close as possible to the sensor in order to effectively drive further electrical stages. The pre-amplifier may incorporate a high input impedance (e.g., >10M Ohm) low noise JFET transistor or commercial electret amplifier chip for impedance conversion and signal gain and may be packaged with the sensor in the microphone housing. Band pass filtering may be employed after signal amplification to emphasize the speech frequency range, such as 300 Hz-4000 Hz.

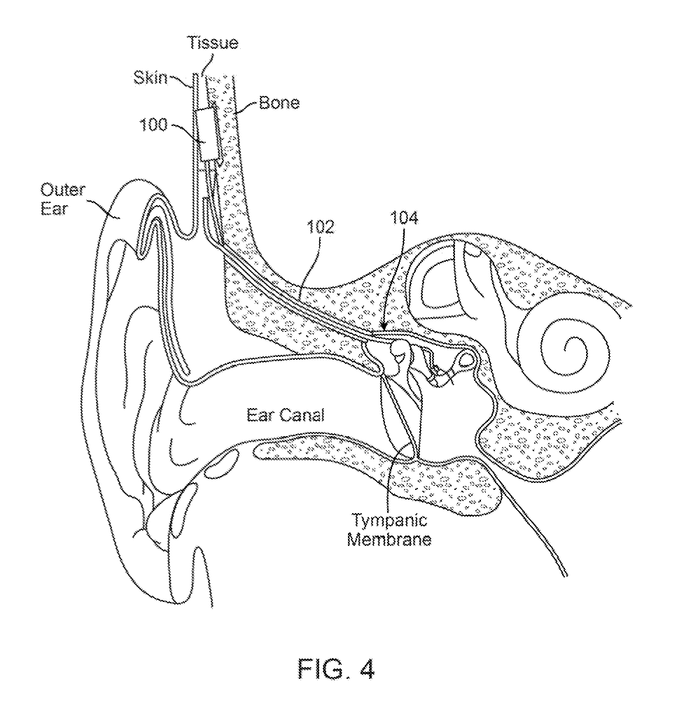

An example of how the piezoelectric polymer microphone may be placed is illustrated in FIG. 4 which shows microphone 100 implanted under the skin of a patient. Microphone 100 may be implanted (either within the subcutaneous tissue, bone, or both) behind or above one or both of the patient's ear(s) in this example with one or more wires 102 electrically coupling the microphone to the bones 104 of the inner ear. The microphone 100 may be positioned just under the skin to receive vibrational waves through the skin such that the microphone 100 may receive the vibrations, as described above. The processed acoustic vibrations may be electronically transmitted through the one or more wires 102 to stimulate the bones 104 of the inner ear to provide the patient the sensation of hearing. The distal end of the one or more wires 102 may be configured to contact and/or be secured to the bones 104 of the inner ear or to tissue in vibrational contact with the bones 104.

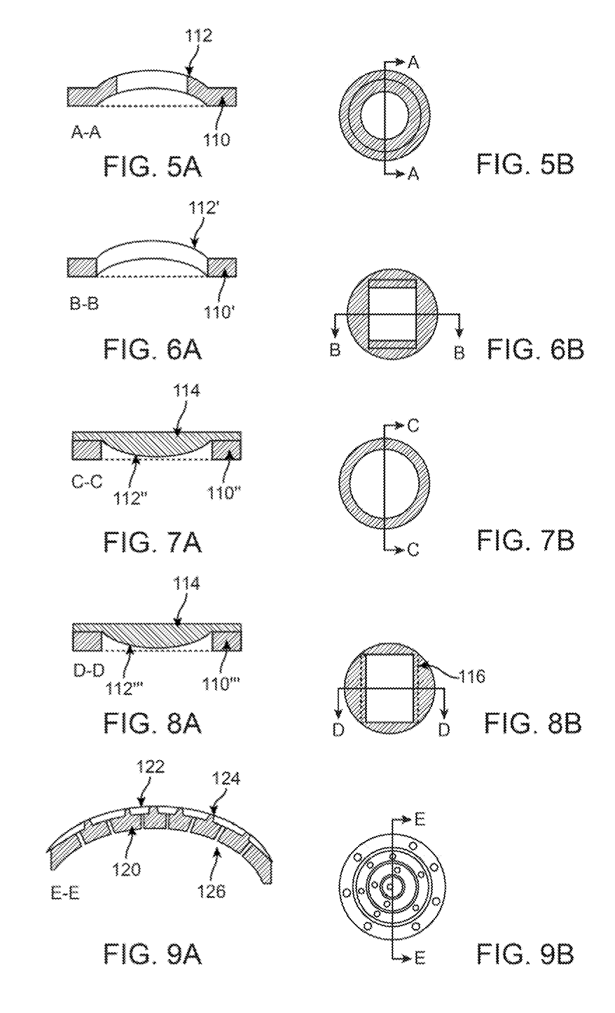

As described above, the frame and piezoelectric polymer film (e.g., PVDF film) contained within the housing of the microphone may be configured in a number of different shapes. FIGS. 5A and 5B illustrate partial cross-sectional side and top views of one example where frame 110 may be configured into a circular configuration having a curved shape. Film 112 may also be circularly configured and positioned upon the frame 110, as shown. FIGS. 6A and 6B illustrate cross-sectional side and top views of another variation where the frame 110′ may be similarly shaped into a circular configuration while the film 112′ may be configured into a square or rectangular configuration supported upon the frame 110′ either along two opposed edges of the film 112′ or around the entire periphery of the film 112′.

FIGS. 7A and 7B illustrate cross-sectional side and top views of another variation of the frame 110″ which is non-curved into a circular configuration and with film 112″ supported around the periphery of the frame 110″. However, in this example, an additional layer of silicone rubber forming a silicone lens 114 may be placed atop the film 112″ such that the film 112″ is sandwiched between the frame 110″ and silicone lens 114. FIGS. 8A and 8B illustrate a similar variation where the film 112′″ may be shaped into a square or rectangular configuration upon the circular frame 110′″ which is non-curved with the silicone lens 114 layered atop the film 112′″ inducing a curvature in the film. However, the film 112′ may be supported along opposite edges or along the entire periphery of the film 112′″ such that the film 112′ is formed into a curved shape formed by the silicone lens 114.

FIGS. 9A and 9B illustrate partial cross-sectional side and top views of yet another variation where a film 122 may be supported via a plurality of protruding supports such as ridges 124 projecting from a circular frame 120. The frame 120 may optionally define one or more openings or holes 126 which allow for communication between the film 122 and an internal air cavity behind the frame.

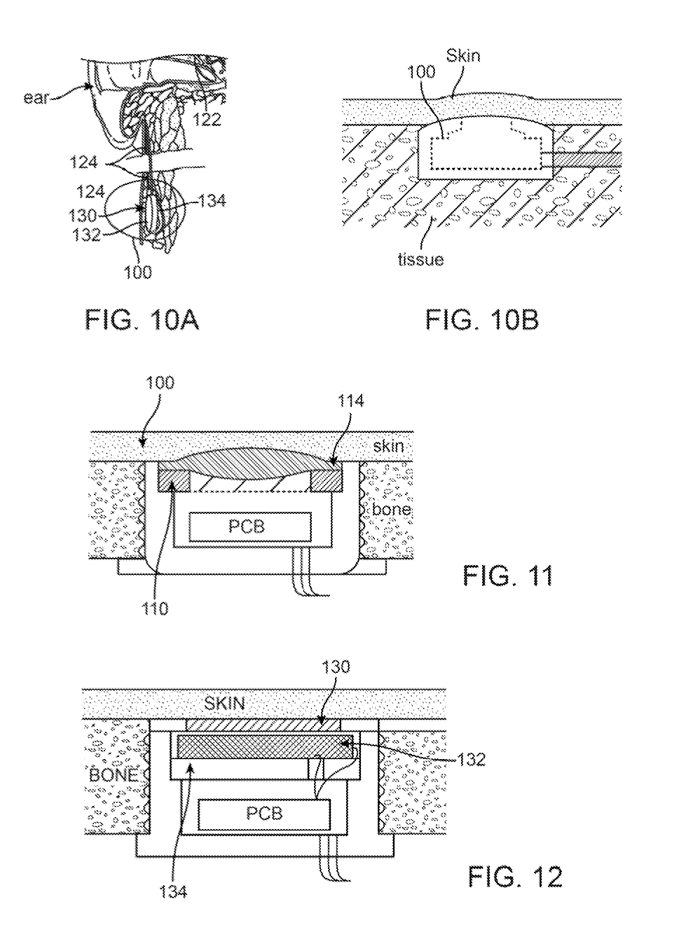

FIGS. 10A and 10B illustrate another variation for implanting the microphone in alternative locations on the body. In this example, the microphone 100 is shown implanted directly into the subcutaneous tissue of the neck below and/or behind the patient's ear rather than secured or anchored within a bone structure. Other soft tissue regions of the body may also be utilized for implantation of the microphone, such as the torso, etc.

FIG. 11 illustrates a cross-sectional side view of another example of the microphone 100 (such as the microphone assembly of FIG. 8) implanted directly within a bone, such as bony wall of the ear canal in which the assembly is anchored, such that the silicone lens 114, formed to have a flattened or curved configuration with a thickness of about, e.g., 0.3 mm to 0.5 mm, may impart its curvature to the film 112 positioned over a lower surface of the silicone lens 114, as previously described. The thickness of the silicone lens 114 may be minimized to limit the mechanical loading on the film 112. The silicone lens 114 may have an upper curved surface which contacts the subcutaneous tissue or skin while both the silicone lens 114 and film 112 are supported by the frame 110. The entire assembly of the silicone lens 114, film 112, and frame 110 may be supported by the implant housing 123 secured to the bone and the film 112 may be in electrical communication with an electronics assembly 121 positioned along, e.g., a printed circuit board, secured within the implant 123. The implant housing 123 may be optionally threaded for facilitating the anchoring into the bone. The electronics assembly 121 may in turn be electrically coupled to the bones of the inner ear, as previously described.

FIG. 12 illustrates a cross-sectional side view of yet another example of a microphone assembly which may be implanted within a bone such that a silicone or other rubber pad 130 may be in contact with the subcutaneous tissue of skin for receiving auditory vibrations. The pad 130 may have a circumferentially oriented piezoelectric polymer film such as PVDF film 132 supported by the implant housing 123 while positioned upon a relatively stiff platform 134. As described herein, as the auditory vibrations are conducted through skin and received by the pad 130, the corresponding changes in size imparted by the pad 130 into the film 132 may be received and processed by the electronics assembly 121 for further electronic transmission into the body.

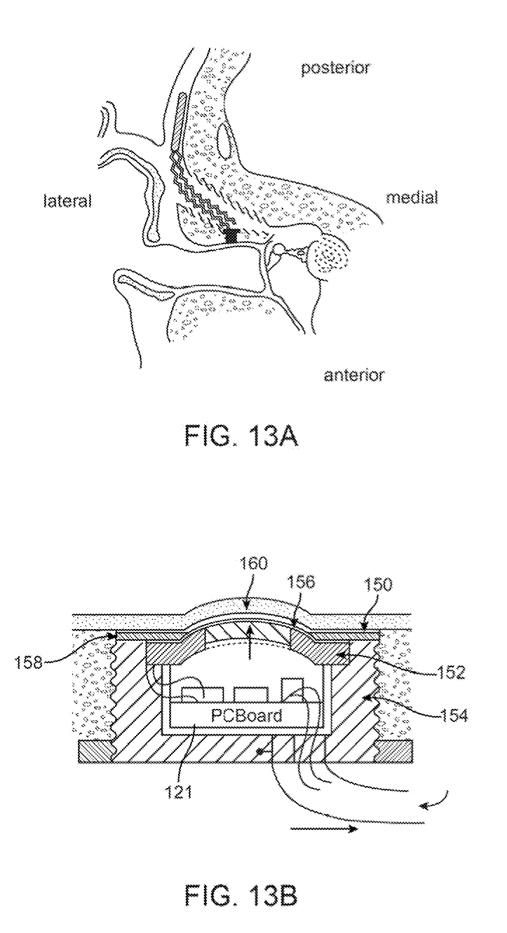

FIGS. 13A and 13B illustrate another example of how the microphone assembly may be implanted into the patient's body. In this example, the circular frame 152 may support the piezoelectric polymer film 156 such that the film 156 may optionally have a curvature (e.g., a radius of curvature of 20 mm to 25 mm) which contacts the subcutaneous tissue or skin 160. The film 156 and/or implant housing 154 (e.g., having a diameter of 8 mm to 10 mm) may be optionally coated with a biocompatible coating, e.g., parylene, which seals the assembly. The implant housing 154 may be secured directly into a bone, such as the skull, via threaded features along the housing or into the tissue underlying the skin 160 (in which case the housing may be at least partially unthreaded for that portion which embeds into the soft tissue) and may further support the frame 150, film 156, and a retaining ring 158 which secures the assembly within the housing 154. The housing 154 may further include one or more flanges, as shown, along a portion of the housing structure which enables the microphone assembly to be anchored or secured at anatomical sites having one or more voids, such as air cavities or air pockets as are commonly found within the bones of the skull or other bony regions of the body. The film 156 may be electrically coupled to an electronics assembly 121 which may be further electrically coupled to the structures of the inner ear via one or more electrical leads or cables which some or all may be shielded, as described herein.

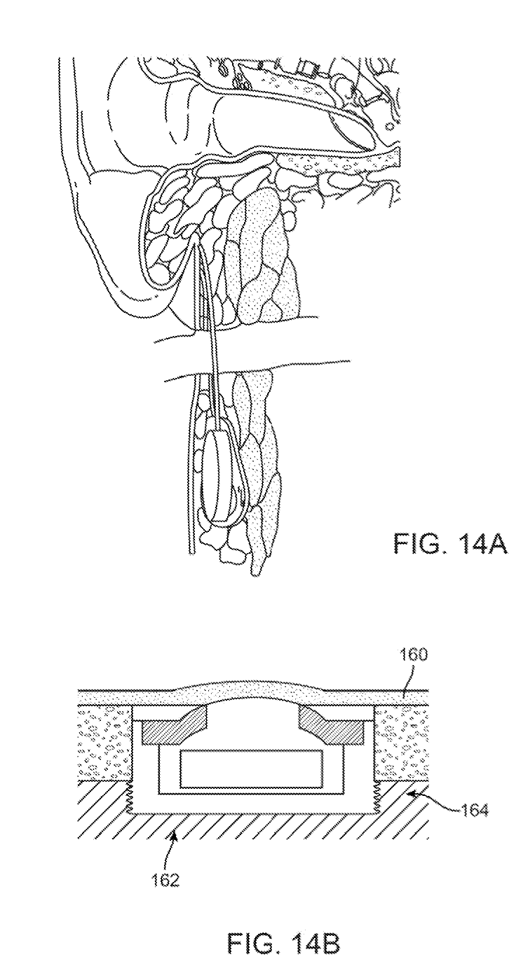

FIGS. 14A and 14B illustrate yet another example of how the microphone assembly 162 may be threaded just partially into the bone 164 while remaining above the bone surface and within the subcutaneous tissue and in contact with the underlying surface of skin 160.

Each of the microphone assemblies disclosed herein and as shown in FIGS. 2 and 5-9 may be incorporated with any of the housings disclosed herein and as shown in FIGS. 11, 12, 13B, and 14B such that the microphone assemblies are anchored or secured in bone, in soft tissue, in a combination of bone and soft tissue, or in a combination of bone adjacent to soft tissue and/or adjacent to a void (such as an air cavity or air pocket). One of skill in the art is capable of matching a particular microphone assembly with a suitable housing such that the implantable microphone device (i.e., microphone assembly and housing) is configured appropriately for the chosen anatomical site of implantation.

Due to size constraints of the microphone itself, the components of the microphone assembly may be separated from one another while remaining in electrical communication. A first assembly, e.g., the microphone, may be separated from a second assembly such as an opposing side of the assembly which may incorporate additional digital signal processing electronics, transmitter or receiver circuitry (or both), an antenna and battery (e.g., lithium ion), depending on the application. Charging may be accomplished using inductive means (in which an induction coil is required in the appliance package) or by direct coupling of exposed electrical contacts.

The implantable piezoelectric polymer film microphone of the present invention may be used as an integral part of a hearing system, such as a middle-ear or cochlear implant. The signals detected by the implantable microphone may be processed/filtered, amplified and wirelessly transmitted using, e.g., near field magnetic induction (NFMI) or low-power radiofrequency (RF) link to an implanted receiving coil and sent to the implanted hearing device control module for further signal processing and stimulation of the middle ear or auditory nerve.

Modification of the above-described assemblies and methods for carrying out the invention, combinations between different variations as practicable, and variations of aspects of the invention that are obvious to those of skill in the art are intended to be within the scope of the claims.

What is claimed is:

1. An implantable microphone assembly, comprising:
a housing configured for subcutaneous implantation within a patient;
a frame positioned within the housing;
a piezoelectric polymer film secured to the frame such that the film is in vibrational contact with subcutaneous tissue;
an electronics assembly in electrical communication with the film; and
one or more wires connected to the electronics assembly at a proximal end and further having a distal end configured for coupling to bones of an inner ear of the patient.

2. The assembly of claim 1 wherein the piezoelectric polymer film is chosen from: PVDF and copolymers of PDVF.

3. The assembly of claim 1 wherein the piezoelectric polymer film comprises PVDF.

4. The assembly of claim 1 wherein the housing is threaded for securement to a bone of the patient.

5. The assembly of claim 1 wherein the frame comprises a curved surface.

6. The assembly of claim 1 further having a silicone lens in contact with the film.

7. The assembly of claim 1 wherein the frame defines one or more openings therethrough in communication with the film.

8. A method of detecting an auditory signal via an implantable microphone assembly, comprising:
positioning a housing beneath a region of skin subcutaneously within a patient such that a piezoelectric polymer film secured to a frame within the housing is in vibrational contact with the region of tissue;
receiving an auditory signal vibrationally transmitted through the region of skin and against the film;
actuating the film via the auditory signal such that an electric signal representative of the auditory signal is produced by the film; and
transmitting the electric signal to an inner ear of the patient.

9. The method of claim 8 wherein the piezoelectric polymer film comprises PVDF.

10. The method of claim 8 wherein positioning a housing comprises securing the housing to a bone beneath the region of skin.

11. The method of claim 8 wherein positioning a housing comprises securing the housing within subcutaneous tissue beneath the region of skin.

12. The method of claim 8 wherein positioning a housing comprises securing the housing to the bony wall of an ear canal.

13. The method of claim 8 wherein actuating the film further comprises processing the electric signal via an electronics assembly positioned within the housing.

14. The method of claim 8 wherein actuating the film comprises imparting an expansion or contraction to a pad secured within the housing and in contact with the film.

15. The method of claim 8 wherein transmitting the electric signal comprises transmitting the signal via one or more wires attached to the inner ear.

16. The method of claim 8 wherein positioning receiving an auditory signal comprises receiving the signal via a tissue contact portion of the housing which has an impedance matched to the region of tissue.
